(19) United States
(12) Patent Application Publication
(10) Pub. No.: US 2015/0284299 A1
(43) Pub. Date: Oct. 8, 2015

(54) COMPOSITION FOR DIP TREATMENT OF PLANT ROOTS

(71) Applicant: AGRAUXINE, Beaucouzé (FR)

(72) Inventors: Antoine Coutant, Beaucouze (FR); Maud-Cécile Reveillaud, Beaucouze (FR); Bachar Blal, Beaucouze (FR)

(73) Assignee: AGRAUXINE, Beaucouzé (FR)

(21) Appl. No.: 14/443,255

(22) PCT Filed: Nov. 15, 2013
(86) PCT No.: PCT/EP2013/073999

§ 371 Date: May 15, 2015

(30) Foreign Application Priority Data
Nov. 15, 2012 (FR) 12/60889

(51) Int. Cl. C05F 11/08; A01N 65/00; C05G 3/02

(52) U.S. Cl. CPC C05F 11/08; C05G 3/02; A01N 65/00

(57) ABSTRACT

The invention relates to a composition for dip treatment of plant roots comprising a substance of interest and a branched polysaccharide, in particular xanthan gum.

The invention relates to the field of fertilizers, and in particular of products intended to improve and stimulate the nutrition, development and growth of plants.

Dip treatment consists in coating the roots of a rosebush, of a tree or of a shrub, or of any other plant, with a mixture that will aid regrowth during planting. Thus, dip treatment promotes healing of the cut parts and helps rosebushes, shrubs and other plants to form new roots and radicles more rapidly.

It is possible to prepare one's own dip treatment mix, using a liquid mixture conventionally consisting of garden soil, water and cow dung, for coating the roots of the plant.

However, commercial dip treatment mixes may contain other compounds intended to promote even faster regrowth. It is thus possible to add cutting propagation hormones, but also mycorrhizal fungi.

A mycorrhiza is the result of symbiotic association between fungi and plant roots. It is a symbiosis between the plant and the fungus. The external filaments of the mycelium combine with the roots of the plants and thus constitute an actual extension of the root system which will explore the soil in the periphery of the root. The mycelial network in the soil can thus reach several million km/hectare, multiplying the prospecting area of the roots by 20 to 25. The mycelium is not partitioned, thus fluidizing transfers of water and mineral elements.

This association is generally of symbiotic type, the fungus contributing to recycling the necromass of its host, to the benefit of both their progeny.

Endomycorrhizae are the most widespread form. Mention may in particular be made of endomycorrhizae with arbuscules or arbuscular mycorrhizae (AMs). Thus, arbuscular mycorrhizal fungi colonize approximately 80% of vascular land plants, i.e. more than 400 000 species, although there are only fewer than 200 species of endomycorrhizal fungi. Thus, since they are not very specific in terms of their symbiotic relationship, each species has a high adaptability potential and a broad genetic diversity.

From a cellular point of view, arbuscular endomycorrhizae cross the cellulose wall but do not penetrate the plasma membrane of the plant cell, limiting themselves to causing an invagination of the membrane of said plant cell. This has the effect of increasing the area of contact between the hypha and the cell of the plant and thus facilitating the metabolite exchange between the two partners.

Arbuscular endomycorrhizae are very broadly fungi of the Glomeromycota division having lost sexual reproduction. The hyphae extend into the cortical parenchyma of the root, forming vesicles containing stores, and branched structures, the arbuscules. They therefore reproduce only asexually. However, the hyphae of different individuals can fuse, thereby making possible a genetic exchange and a form of parasexuality.

The mycorrhization of plants by mycorrhizal fungi makes it possible to improve several physiological processes of plants, in particular mineral and hydric nutrition, hormonal regulation, and defense mechanism stimulation.

These effects result in greater resistance of plants to the stress of repotting or of planting, thus making it possible to obtain a better rate of regrowth of plants during this crucial step in the establishment of certain crops (wine growing, tree cultivation, ornamental crops, etc.).

Among the endomycorrhizal fungi, mention may be made of the genus Glomus sp and more specifically the strain Glomas spp coded LPA Val1, the active ingredient of the product Solrize® developed by the applicant, and having obtained approval in France (No. 1020004). Solrize® makes it possible to form mycorrhizae in plants and has the effect:
of optimizing the regrowth thereof;
of homogenizing planting;
of improving the resistance thereof to (abiotic and biotic) stresses;
of promoting the taking root thereof;
of improving the nutrition thereof;
of reducing the provision of inputs.

The product Solrize® is in granule form and contains the endomycorrhizal fungus Glomus sp at a minimum concentration of 10 propagules per gram. The commercial product Solrize® can be used as dip treatment mix. In this case, it is sold under the name Solrize® Pralin by the applicant. One bag of Solrize® Pralin contains 3.5 kg of Solrize® and one 1 kg sachet of dip treatment mix. The dip treatment mix consists mainly of clay and a thickener. The final product is obtained by adding water to these two elements, and mixing all of it so as to obtain a homogeneous paste. The formulation of Solrize® Pralin is very suitable for forming mycorrhizae in (therefore treating) plants with bare roots, just at the time they are planted. This relates in particular to vine plants, fruit tree plants, ornamental shrubs, etc. The formulation of the Solrize® Pralin preparation is particularly suitable for the dip treatment of plants that are not handled very often, or even not at all, before or at the time of planting in the hole. This is because Solrize® Pralin allows good adhesion of the product to the roots of the plants, but the clay used in its formulation dries quite rapidly. This drying leads to a loss of adhesion of the product to the roots of the plant, resulting in a loss of active substance applied to the roots, in particular if the plants are handled too much or if the time between dip treatment and planting is considerable. This risk of loss of active substance on the roots can therefore result in a variability in the dose of Solrize product per plant, or even a loss of expression of the claimed effects of the Solrize product due in particular to insufficient doses of product per plant.

Solrize® Pralin makes it possible to have excellent results for plant regrowth. However, in the constant interest of optimizing the working time, an increasing number of plantings are done by nurserymen who supply the plants. In this case, the plantings are mechanized, and the plants are sometimes prepared the day before and grouped together in containers. This process allows a higher hourly yield (number of plants planted/hour), but the mechanization leads to increased handling of the plants. Faced with this mechanization of planting, the Solrize® Pralin preparation is not necessarily the most suitable.

The applicant has therefore sought to develop a novel dip treatment formulation which is suitable for this new planting context, i.e. which allows the preparation of “dip-treated” plants several hours before planting, and which allows handling of the plants thus dip-treated.

US 2007/163173 describes a polymer of grafted and crosslinked starch for preparing a gel for dipping plant roots. The grafted and crosslinked starch probably cannot be described as a branched polysaccharide.

WO 2004/005219 describes a composition for the rhizobium inoculation during plant germination and growth. However, this composition does not contain branched polysaccharide and is intended to coat the seeds (see page 12, last paragraph), whereas the composition according to the invention is intended for dip treatment, i.e. for coating the roots.

U.S. Pat. No. 5,344,471 describes dip-treatment compositions for providing plant roots with a mycorrhizal microorganism. Numerous putative compositions (methylcellulose, carboxymethylcellulose, hydroxypropylmethylcellulose, etc.) are listed, as are numerous microorganisms.

U.S. Pat. No. 4,975,105 D4 discloses a composition for dip treatment of plants, comprising a superabsorbent polymer such as crosslinked starch and a mycorrhizal fungus.

U.S. Pat. No. 6,258,749 discloses a formulation which can be used for dip treatment of plants, comprising one or more polyacyl glucosides and a substance of agronomic interest, such as nutrients (iron, manganese).

None of these treatments either describes or suggests the technical problem that the applicant seeks to solve in the context of the present invention, i.e. the possibility of preparing dip-treatment compositions well before use and/or of preparing dip-treated plants and storing them for several hours or several days before planting. Moreover, the compositions are prepared by dissolving a polymer in an aqueous system, and then adding the agent of interest (endomycorrhiza), which requires two steps of intervention and mixing (the polymer with the liquid system and then the polymeric system with the agent of interest).

In a first aspect, the invention relates to a composition for dip treatment/coating of roots, comprising a branched polysaccharide, and also a substance of interest that it is desired to provide to the plant. Another subject of the invention is the use of a branched polysaccharide for preparing a composition intended to receive an active ingredient or a substance of interest and to be used for the dip treatment/coating of plant roots. Said active ingredient may be any microorganism or any other substance intended to be provided to a plant that it is desired to plant, in order in particular to improve the regrowth, to make it possible to combat pathogens or diseases, or to improve the production of plant biomass. It may also be a combination of active ingredients.

This composition is also called Mycogel®.

In one particular embodiment, said composition is in the form of a gel, which in particular allows good adhesion to plant roots.

A method for providing a substance of interest to the roots of a plant, comprising the steps of (i) integrating said substance of interest into a composition comprising a branched polysaccharide in order to obtain a dip-treatment composition (or preparing a dip-treatment composition containing said substance of interest and a branched polysaccharide) and (ii) applying this dip-treatment composition to the roots of said plant (in particular by dipping the roots in said dip-treatment composition), is also a subject of the invention. The application of this dip-treatment composition to the roots of the plant will thus be able to lead to the coating of said roots, thus making it possible to provide the substance of interest to the plant.

A substance of interest is a substance which is used in the agronomic field for application thereof to plants or vegetables, in particular in order to improve the health, growth and/or biomass development of these plants or vegetables.

Said substance of interest (active ingredient) is in particular chosen from microorganisms, in particular fungal microorganisms (endomycorrhizal or exomycorrhizal fungi, hyphomycetes, ascomycetes, including Trichoderma spp, actinomycetes, deuteromycetes), bacteria (in particular Bacillus and Lactobacillus spp, Paenibacillus spp, Azospirillum spp, Pseudomonas spp) or else natural substances of oligosaccharide, peptide, glycolipid, plant or algal extract, or essential oil type.

The invention also relates to a composition having a particle size of less than or equal to 5 mm, which comprises:
particles of branched polysaccharide, having a diameter of greater than 70 microns, preferably greater than 100 microns, more preferably greater than 150 microns, and less than 250 microns, more preferably less than 200 microns;
an active ingredient of interest which is in “dry” form (such as a dried or lyophilized microorganism or natural substance, or spores or propagules for fungal microorganisms);
optionally, particles of a neutral matrix (such as clay) stabilizing the active ingredient.

Preferably, this composition has an Aw (water activity) of less than or equal to 0.95. This composition is therefore solid (as opposed to a liquid composition, a composition in suspension in a liquid, or a pasty or gelled composition), and is preferentially particulate. The size of the particles in this composition is variable depending on the constituents. Thus, the fungal spores are generally smaller than the particles of the branched polysaccharide, which are themselves smaller than the particles of neutral matrix. On the other hand, a certain homogeneity is desired for the size of each of the constituents.

Normally, the water activity is measured on small samples hermetically enclosed in a measuring compartment equipped with a humidity-sensitive element. During the successive measurement of several samples, the sensitive element goes through a complete humidity cycle at each measurement. This operation must not influence the accuracy of the measurement, nor cause hysteresis of the output signal. Finally, volatile additives must not influence the sensitive element. The humidity-sensitive elements Hygromer® and Hygrolyt® from Rotronic (Switzerland), or LabSwift-aw® from Novasina (Switzerland) meet these criteria.

This water activity measurement is therefore common and well known in the art.

This composition makes it possible to obtain the dip-treatment composition according to the invention through the addition of a suitable amount of water.

In particular, this composition contains between 6 and 15 g of branched polysaccharide if it is desired to add one liter of water.

The amount of active ingredient is determined according to the nature of the active ingredient. For an endomycorrhizal fungus, between 3000 and 4000 propagules per 1 liter of water are used. For a Trichoderma, between 0.05 and 0.2 g/l of spores, preferably between 0.08 and 0.12 g/l (10⁸ to 10⁹ CFUs per gram), are used.

Preferably, in this embodiment, the branched polysaccharide is xanthan gum.

Preferably, the active ingredient is an endomycorrhizal fungus, as listed below, in particular of the genus Glomus sp, belonging to the glomeromycete group. The propagules are preferentially stabilized with clay or any other neutral support.

In another embodiment, the active ingredient is a fungus of the genus Trichoderma.

In another embodiment, the active ingredient is a mixture of Trichoderma and Glomus.

The invention relates in particular to the use of a branched polysaccharide, and in particular xanthan gum, for preparing a composition also containing an endomycorrhizal fungus (or another substance of interest), and intended for root dip treatment/coating. The composition thus obtained is either the particulate composition or the composition directly useable for dip treatment (particulate composition to which the required amount of water has been added). The methods for preparing a composition, comprising the mixture of a branched polysaccharide, and in particular xanthan gum, and a substance of interest (in particular an endomycorrhizal fungus), with or without subsequent addition of water, are also a subject of the invention.

The invention thus relates to the use of a branched polysaccharide for preparing a composition intended to provide a substance of interest to the roots of a plant by dip treatment. In one particular embodiment, said composition has been prepared a few days (the day before, 2 or 3 days, or even up to 7 days or one month) before application to the plant.

Generally, it is desirable for the composition intended for the dip treatment to be able to allow good dispersion of the substance of interest, and for it to be possible to impregnate the roots easily (in particular by dipping, which means that the composition can be made liquid, in particular by working it mechanically) and for this composition to persist (solidify) on the roots of the target plant after application to said roots. It is therefore preferentially a composition which is gelled at ambient temperature, but which liquefies when it is worked. This thus allows storage and handling of the plants after application of the composition to the roots.

The use of a branched polysaccharide (and in particular of xanthan) thus makes it possible to obtain a gel which liquefies when it is worked (by shearing) and in which the fungus (or any other formulated substance of interest) is homogeneously premixed (in the gel), so as to then dip the plants with bare roots in bunches (of 25 or 50 plants) directly into a large tub, this being from the warehouse before planting. This gel hardens after dipping the plants to give better attachment and limitation of losses during handling (transportation, etc.). Preferably, the efficiency of mycorrhization (or of the substance of interest) should be maintained, or even accentuated. Finally, this “branched polysaccharide-based agar” composition has an ability to age and to be stored for use spread out over 2 to 3 days. This branched polysaccharide thus has gelling properties preferentially when it is brought into contact with water.

The invention thus relates to a composition for dip treatment, comprising an endomycorrhizal fungus (or another substance of interest) and a branched polysaccharide. This composition is preferentially in the form of a gel, the viscosity of which decreases when it is mixed. Thus, the viscosity of the gel is decreased under the effect of shear forces.

The invention also relates to the use of an endomycorrhizal fungus (or of another substance of interest) and of a branched polysaccharide for preparing a composition intended for dip treatment of the roots of a plant.

The applicant has in fact shown that it is possible to use a branched polysaccharide for preparing a composition intended to provide an endomycorrhizal fungus (or any other substance of interest) to a plant, in particular to the roots thereof. The preparation of this composition (gel) can be carried out on the actual day of or else a few days (the day before, 2, 3, or even up to 7 days) before the day of use (application to the plant) thereof and can thus be stored. The optimum delay before use of the gel ranges from 2 to 7 days depending on the storage temperature of the preparation produced.

The branched polysaccharide is biodegradable, i.e. it can be degraded by the microorganisms in the soil without leaving toxic residues. This polysaccharide will not therefore be toxic to the environment or to living beings. Use may in particular be made of any polysaccharide having received a marketing authorization as a food additive.

Preferably, this branched polysaccharide is not galactomannan. In particular, this branched polysaccharide is such that it comprises several monosaccharide units on its branches, in particular 3 monosaccharide units.

In one preferred embodiment, the branched polysaccharide consists of a combination of glucose, mannose, glucuronic acid and pyruvic acid. In particular, it is xanthan gum (CAS: 11138-66-2; EINECS: 234-394-2) , of empirical formula C₃₅H₄₉O₂₉.

This xanthan gum is preferably in a pulverulent form. In one particular embodiment, at least 80% of the particles present in this powder have a size between 150 and 200 microns. In another embodiment, the particles have a size of less than 177 microns. Indeed, a xanthan gum of 80 MESH is preferably used.

The notion of MESH is used to define the fineness of abrasives. The value associated with the MESH expresses the number of meshes per inch. Thus, the Mesh unit expresses the number of meshes of a sieve per inch (1 inch=2.54 cm). Consequently, the more meshes there are, the higher the Mesh number is, and the finer the sieve will be. Thus, the size of the largest particles capable of passing through the sieve will then be smaller.

Thus, particles of 80 Mesh have a maximum size of 177 microns. In the context of the present invention, particles of 70 Mesh (maximum size of 210 microns) or particles of 100 Mesh (maximum size of 149 microns) could also be used. The composition according to the invention is prepared by mixing the endomycorrhizal fungus with the branched polysaccharide, then adding water to this mixture. The water may be cold water or warm water.

The size of the xanthan gum particles may prove to be important for implementing the invention. This is because a fine particle size (200 mesh) will make it possible to have a faster hydration of the gum, but with the risk of there being lumps. A coarser product makes it possible to have a better dispersion and to avoid the formation of lumps, in particular under the working conditions in the field or in a workshop (weak stirring conditions). This is why it is preferable to use particles having the sizes mentioned above (approximately between 150 and 200 microns, although particles of 210 microns can be used). In summary, the size of the particles is preferentially less than 250 microns, preferably less than 70 mesh, or 200 microns, and greater than 100 mesh (or 150 microns).

If the formulation is carried out with large devices, it is possible to go as far as using particles of 200 mesh (74 microns).

The size of the particles is thus greater than 70 microns, more preferably 100 microns, more preferably 150 microns.

In one preferred embodiment, this composition comprises only said endomycorrhizal fungus, said branched polysaccharide and also water (and optionally a neutral support stabilizing the fungus, such as clay). In another embodiment, the composition contains only the substance of interest, said branched polysaccharide and also water (and optionally a neutral support stabilizing the fungus, such as clay). Thus, in these embodiments, the composition contains just one compound which has an activity on the plant.

In another embodiment, other compounds can be added to this composition, such as cutting propagation hormones or, quite obviously, other beneficial microorganisms or substances which can have effects complementary to Solrize® (Trichoderma spp, Bacillus and Lactobacillus spp, Paenibacillus spp, Azospirillum spp, Pseudomonas spp, hyphomycetes, ascomycetes, actinomycests, deuteromycetes, oligosaccharides, peptides, glycolipids, plant or algal extracts, essential oils, etc.).

Any type of fungus (endomycorrhizal or ectomycorrhizal) can be used in the context of the present invention. However, use is preferably made of an arbuscular endomycorrhizal fungus, and in particular a fungus of the genus Glomus sp and belonging to the glomeromycete group and in particular the Glomus sp strain LPA Val1, which is the active ingredient of the product Solrize® developed by the applicant, having obtained an authorization in France (No. 1020004). Solrize® is in the form of clay containing Glomus sp spores and mycelium combined with clay particles and with plant root fragments.

Those skilled in the art are capable of determining the amounts of each of the products to be provided in order to produce the composition according to the invention, knowing that it is desired to provide between 3 and 10 g of mycorrhizal inoculums per dip-treated plant (i.e. between 30 and 100 propagules) according to the size of the root system.

In the case of the use of another substance of interest, those skilled in the art will determine the amount to be provided to the plant, which will make it possible to identify the concentration to be used according to the average amount of product that will be present on the roots of this plant.

Moreover, those skilled in the art are capable of determining the amount of polysaccharide to be added to the composition in order to obtain the appropriate viscosity and mechanical behavior.

In one particular embodiment, the composition comprises between 3000 and 4000 propagules of said endomycorrhizal fungus, and between 7 and 15 g of said xanthan gum, for 1 liter of water. This amount of xanthan gum is the preferred amount for all the applications envisioned in the application. Between 6 and 10 g of xanthan gum for 1 liter of water may also be used. At least 6 g, preferably at least 7 g of xanthan gum for 1 liter of water, and at most 15 g, preferably at most 12 g of xanthan gum for 1 liter of water, are thus used.

As seen above, the invention also relates to the use of a composition as described above for carrying out a dip treatment, or as a biofertilizer.

This dip treatment or this use as a biofertilizer can be performed on any type of plant capable of forming an endomycorrhiza. It is in particular carried out on any crop which may be the subject of planting. Use in the fields of fruit tree cultivation, winemaking, ornamental trees and shrubs, forestry, and vegetable crops is thus envisioned.

Mention may be made of market garden crops, such as melon, tomato, strawberry, eggplant, sweet peppers, courgettes, lettuce or beans, fruit trees such as apple trees, pear trees, plum trees, cherry trees, etc., or any horticultural plants or floral crops (including rosebushes). Mention may also be made of use for trees (walnut, ash, plane tree, poplar, service tree, etc.) or shrubs (bay-tree, box tree, St. John's Wort, lilac, buddleia, etc.).

It has in particular been shown that this composition can be used on vine plants from a conventional nursery.

The invention also relates to a method for planting a plant, comprising the step of planting a plant in a substrate which allows growth of the plant, characterized in that the plant roots are coated with a composition according to the invention. Said substrate may be earth, compost or any other substrate suitable for the plant in question. It may also contain elements such as peat or clay.

In one preferred embodiment, the coating of the roots of the plant was carried out more than 12 hours, more preferably more than 24 hours, more preferably more than two days, or even more than one, or even two, weeks before the step of planting the plant, in particular for vine plants. The plants are stored directly in the dip-treatment composition according to the invention, or immersed in the composition and removed therefrom, the composition then hardening while adhering to the roots of the plants which are then stored until planting.

The examples show in particular that it is possible to store vines in the composition according to the invention for more than three weeks and at least one month.

### EXAMPLES

### Example 1

### Test of Several Products

The following products were tested:
Guar 25: composed mainly of galactomannan (linear polymer composed of a chain of mannose monomers ((1,4)-beta-D-mannopyranose) to which a unit of galactose is branched via a 1-6 bridge).
Xanthan 80 (Danisco®, xanthan gum 80 mesh): branched polysaccharide comprising 4 monosaccharide units in the branches.
LBG 246 (locus bean gum): thickening properties due to galactomannan.
FD 175 (alginate): linear polymer formed from two monomers linked together: mannuronate and guluronate.

The gelling power of these products was tested.

| Name | Dose tested 1% | Dose tested 0.2% | Conclusion |
|---|---|---|---|
| LBG 46 | Very liquid | Very liquid | Very liquid |
| Locus bean gum | appearance, | appearance, with | gum |
| | with few lumps | few lumps | |
| Alginate FD 175 | Rather viscous | Rather viscous | Gelling gum |
| | appearance, | appearance, but | with rather |
| | but many lumps | many lumps | a viscous |
| | | | tendency |
| Guar type 250 | Liquid | Liquid | Very liquid |
| | appearance | appearance with | gum |
| | with a few | lumps | |
| | lumps | | |
| Xanthan 80 | Very viscous | Less viscous | Viscous and |
| | appearance, a | appearance, | gelling gum |
| | few lumps | fewer lumps | |
| | | (starting base) | |

From a texture (binding) point of view, the xanthan and the alginate appear to be more binding than the guar and the locus bean gum and would therefore be the most capable of meeting the expectations of nurserymen, in particular with regard to the capacity to be in liquid form for mixing the substance of interest and applying the product to the roots, and to subsequently solidify (on the roots), thereby allowing the dip-treated plants to be handled (specifications).

In the light of these results, only the alginate and the xanthan gum appear to be useable in the application envisioned.

However, it may be noted that it appeared to be difficult to dissolve these gums in water even at a low dose. The results are the same with hot water.

### Example 2

### Improvement of Solubility

Various dispersants were tested in an attempt to solve the problem of dissolution of the gums in water.

| Name of | | |
|---|---|---|
| binding agent | Appearance | Conclusion |
| LBG 46 | Not homogeneous, | Gel too liquid |
| Locus bean gum | oil rises, very | |
| | liquid | |
| Alginate FD 175 | Not homogeneous, | Gel too liquid |
| | oil rises, liquid | |
| Guar type 250 | Homogeneous liquid | Gel getting closer |
| | mixture, slightly | to the expected |
| | but not very thick | specifications |
| Xanthan 80 | Very homogeneous | Gel corresponding to |
| | mixture, | the expected |
| | gelatinous | specifications |
| | appearance | |

Protocol applied: 5 g of dispersant+0.5 g of binding agent+97 ml of water

Other tests showed that xanthan gum is the product which makes it possible to obtain a composition having the best expected viscosity properties.

In particular, a test was carried out which consisted in dipping a vine plant in all the solutions prepared in order to evaluate the adhesion of the gels around the roots.

The results are most promising for xanthan.

### Example 3

### Determination of Easy Use of the Composition

The production of the composition consists in mixing the product Solrize® Standard with powder of the selected binding agent (in the case in point, xanthan in this example) and then adding water in order to obtain a homogeneous and binding product. This principle is simple for the user to implement.

The preparation of this new formulation should be as simple as that of the product Solrize Pralin: the binding agent is directly mixed with the Solrize®, then the water is subsequently added.

The tests carried out on the various products show that only xanthan makes it possible to obtain a composition which satisfies the criteria sought for the product (easy mixing, good adhesion of the preparation to the roots and plants).

Indeed, the tests with alginate give a product which hardens over time. The tests with guar or locus bean gum give compositions which are too liquid.

### Example 4

### Preparation of Various Compositions

| Composition of | Amount of | | | | |
|---|---|---|---|---|---|
| the preparation | Solrize ® | | | | |
| tested | (g/vine plant) | D + 1 | D + 2 | D + 3 | D + 7 |
| 175 g Solrize ® + | 5.83 g | Homogeneous | Hard on top, but | Idem | Begins to |
| 12 g Xanthan + | Solrize ®/ | product binds | after mixing, | D + 2 | harden, a |
| 850 ml H₂O | plant | well to | idem D + 1, | | few lumps |
| | | the roots | therefore | | after mixing |
| | | | satisfactory | | |
| 175 g Solrize ® + | 5.2 g | Homogeneous | Hard on top, but | Begins to | Has hardened, |
| 18 g Xanthan + | Solrize ®/ | product binds | after mixing, | harden, a | a few lumps |
| 850 ml H₂O | plant | well to | idem D + 1, | few lumps | after mixing |
| | | the roots | therefore | after mixing | |
| | | | satisfactory | | |
| 175 g Solrize ® + | 4.8 g | Homogeneous | Hard on top, but | Begins to | Has hardened, |
| 24 g Xanthan + | Solrize ®/ | product binds | after mixing, | harden well, | difficult to |
| 850 ml H₂O | plant | well to | idem D + 1, | a few lumps | mix without |
| | | the roots | therefore | after mixing | producing |
| | | | satisfactory | | lumps |
| 175 g Solrize ® + | 4 g | Homogeneous | Hard on top, but | Begins to | Has hardened, |
| 30 g Xanthan + | Solrize ®/ | product binds | after mixing, | harden well, | difficult to |
| 850 ml H₂O | plant | well to | idem D + 1, | a few lumps | mix without |
| | | the roots | therefore | after mixing | producing |
| | | | satisfactory | | lumps |

The products were evaluated at ambient temperature, and a manual control for adhesion to the roots of a vine plant, used as a model, was performed.

It is noted that the compositions can be stored for at least two days, or even for longer.

Other compositions were prepared, comprising: 360 g of Solrize, 850 ml to 1.5 l of water and various amounts of Xanthan 80 gum.

It is observed that the best results are obtained when between 7 and 15 g of Xanthan 80 are added.

It was noted that the composition comprising 360 g of Solrize®, 1 liter of water and 10 g of Xanthan 80 appears to exhibit the most favorable properties.

### Example 5

### Test of Application of the Selected Composition to Vine Plants

A composition comprising 360 g of Solrize®, 1000 ml of water and 10 g of Xanthan 80 is therefore tested.

| Number of | | | |
|---|---|---|---|
| vine plants | Amount of | | Amount of |
| which can be | gel + Solrize ® | Amount of gel | Solrize ® |
| dip treated | (g/vine plant) | (g/vine plant) | (g/vine plant) |
| 120 | 11 to 13 g/plants | 6 to 8 g/plants | 3 g/plant |

The pH of the composition was measured over time:
pH gel=7.15 (D+1)
pH gel+Solrize®=7.01 (D+1)
pH gel+Solrize®=7.70 (D+2)
pH gel+Solrize®=7.00 (D+3)
pH gel+Solrize®=6.90 (D+4)
pH gel+Solrize®=6.90 (D+5)

The storage of the product at ambient temperature does not give rise to any odor before D₊4, whereas Solrize® Pralin emits odors as early as 24 h after preparation.

At 4° C., the storage can reach 7 days after preparation without any particular odor being noted. The odor reflects a change in the product which can lead to a modification of its properties.

Moreover, an economic analysis made it possible to calculate that the cost price of the compositions according to the invention is significantly lower than the cost price of Solrize® Pralin.

The compound therefore remains particularly stable over time once prepared, thus allowing a certain flexibility with respect to its use.

### Example 6

### Plant Mycorrhization Test

### Procedure

Bean, vine, sorghum and chrysanthemum plants were dip treated using a test preparation prepared on the basis of the results obtained during the tests previously described.
Dip-treatment formulation tested: 360 g Solrize®+10 g Xanthan 80+l H₂O.
Repotting/planting: carried out in 4 l containers (pots).
Modes:
   Control (not dip treated): 5 plants (pots) per species, i.e. 20 pots;
   “Soirize Gel”: 10 plants per species dip-treated using the preparation tested above, i.e. 40 pots.
Culture support: Prorize compost from the company Aquiland (33000 Landiras France).
Culture time: 6 weeks.

### Results

After 6 weeks of culture (period sufficient to have roots having formed mycorrhizae, appearance of the points of infection between Glomus and the plant roots), the roots of all the plants were sampled in order to test for the setting up of mycorrhization. The control plants (not treated with the composition) were negative (no formation of mycorrhizae), making it possible to validate the test. All the 40 plants treated (dip-treated) with the composition showed the presence of mycorrhization.

These results make it possible to demonstrate that the composition according to the invention allows plant mycorrhization.

Other tests, in particular in the vineyard under real planting conditions, were carried out on vine plants and made it possible to validate the technical advantage of such a “Gel” dip-treatment formulation and also its efficiency in obtaining in particular good regrowth rates and a better quality of plants, significantly different than the non-dip-treated control mode.

### Example 7

### Test of Compatibility with Trichoderma Spores

Preparation of the Mycogel®:
Solrize® Pro (Agrauxine): 360 g
Xanthan gum: 10 g
Water: 1 l

Trichoderma:
Pure Trichoderma spores: 0.1 g/l (10⁸ to 10⁹ CFU/g).

Microbiological testing:

Determination of the Trichoderma CFU/g on PDA (potato dextrose agar) medium and determination of the bacterium CFU/g on PCA (plate count agar) medium.

The Mycogel and the Trichoderma spores are mixed and then stored at ambient temperature and at 4° C. for one week.

A sample is taken for the two modes (ambient temperature and at 4° C.) and the microbiological testing is carried out.

The sample is mixed in Tryptone salt for 30 minutes and then successive dilutions are prepared. The dishes are read after 72 hours of incubation.

Parameters measured:
Trichoderma CFU per g
Contaminant CFU per g.

### Results

| | Mycogel + | |
|---|---|---|
| | Trichoderma spore | Mycogel + |
| | mixture at ambient | Trichoderma spore |
| Modes | temperature | mixture at 4° C. |
| Viable Trichoderma CFU/g | 1.67 × 10⁷ CFU/g | 1.02 × 10⁷ CFU/g |
| Viable bacterium CFU/g | 3.01 × 10⁵ CFU/g | 1.97 × 10⁵ CFU/g |

### Conclusion

The Mycogel® and Trichoderma mixture is compatible. Furthermore, no difference is observed in terms of survival irrespective of the gel storage temperature.

### Example 8

### Mycogel® Storage Test

### Setting Up of the Protocol

Host plant: vine
Container: 3 l bucket
Solrize® Standard: Batch No. 33
Mycogel® dose: for treating 120 vine plants
   Solrize® Pro: 360 g
   Xanthan gum: 10 g
   Water: 1 l.

### Parameters measured: twice/month

Monitoring of the odor coming from the buckets.
Measurement of the pH

### Results

The formulated Mycogel® can be stored without problems for 1 month at 4° C. Beyond this, an odor linked to the fermentation of the Mycogel is given off, although virtually no variation in pH is observed.

These results show that wine producers can dip the vine in the Mycogel® and store them at 4° C. for a few weeks before planting.

On the other hand, it is not advised to store the vines in the Mycogel® for 6 months before planting.

The storage of the gel alone (without Solrize®) gave results of the same type: the gel can be stored for 1 month at 4° C., and an odor linked to the fermentation of the gel is given off beyond this. Virtually no variation in pH is observed over the course of six months of storage.

### Percentage of Mycorrhization

All the modes at +6 months, +4 months and +2 months for the vines which are at 4° C. and fresh were repotted in 1 l pots with Falienor® substrate and then placed in a greenhouse. Because the pH is maintained, it is suspected that the mycorrhization will remain possible and will be of quality. The tests are ongoing.

### Example 9

### Storage of Dip-Treated Plants Before Planting

The degree of mycorrhization for plants stored in Mycogel® at 4° C. for one month was also tested.

Ten vines were dipped in Mycogel and then placed at 4° C. After four weeks, the vines were removed from the cold room at 4° C. and repotted in 1 l pots with Falienor® substrate and then placed in a greenhouse.

After 9 weeks of culture, only the percentage of mycorrhization is observed on the 10 vines.

| Vine plant | % degree of | Mean % degree of |
|---|---|---|
| number | mycorrhization | mycorrhization |
| 1 | 25% | 21.2% |
| 2 | 30% | Internal structures |
| 3 | 20% | not very developed |
| 4 | 15% | (presence of external |
| 5 | ND | mycelium, vesicle) |
| 6 | 25% | |
| 7 | 15% | |
| 8 | 10% | |
| 9 | 22% | |
| 10 | 29% | |

It is noted that the degree of mycorrhization is 21.2% for the vine. Storage of the vines in Mycogel at 4° C. for 1 month does not affect its efficiency and therefore vine mycorrhization.

1. A composition intended for dip treatment of a plant, comprising a branched polysaccharide and also a substance of interest.

2. The composition as claimed in claim 1, characterized in that said substance of interest is an endomycorrhizal fungus.

3. The composition as claimed in claim 2, characterized in that said endomycorrhizal fungus is a glomeromycete.

4. The composition as claimed in claim 1, characterized in that said substance of interest is an antifungal microorganism.

5. The composition as claimed in claim 4, characterized in that said antifungal microorganism is a Trichoderma.

6. The composition as claimed in claim 2, characterized in that it also comprises an antifungal microorganism.

7. The composition as claimed in claim 6, characterized in that said antifungal microorganism is a Trichoderma.

8. The composition as claimed in claim 1, characterized in that said branched polysaccharide consists of a combination of glucose, mannose, glucuronic acid and pyruvic acid.

9. The composition as claimed in claim 1, characterized in that said branched polysaccharide is xanthan gum.

10. The composition as claimed in claim 9, characterized in that said xanthan gum is in a pulverulent form of particles having a size of less than 177 microns.

11. The composition as claimed in claim 1, characterized in that it comprises only said substance of interest, said branched polysaccharide and also water.

12. The composition as claimed in claim 2, characterized in that it comprises between 3000 and 4000 propagules of said endomycorrhizal fungus for 1 liter of water.

13. The composition as claimed in claim 9, characterized in that it comprises between 6 and 15 g of said xanthan gum, for 1 liter of water.

14. The composition as claimed in claim 1, characterized in that it is in the form of a gel.

15. A particulate composition which comprises:
a) particles of branched polysaccharide, having a diameter of greater than 70 microns, and less than 250 microns;
b) an active ingredient of interest which is in “dry” form;
c) optionally, a neutral matrix stabilizing the active ingredient.

16. The composition as claimed in claim 15, characterized in that said branched polysaccharide is xanthan gum.

17. The composition as claimed in claim 15, characterized in that said active ingredient of interest is an endomycorrhizal fungus, in the form of propagules, which is optionally stabilized with clay.

18. The composition as claimed in claim 15, characterized in that said active ingredient of interest is a Trichoderma, in the form of spores.

19. The composition as claimed in claim 15, characterized in that said active ingredient of interest is a mixture of Trichoderma, in the form of spores, and of an endomycorrhizal fungus, in the form of propagules.

20. A method for preparing a composition, comprising a step of adding water to a composition as claimed in claim 15.

21. (canceled)

22. (canceled)

23. A method for providing a substance of interest to the roots of a plant, comprising the steps of (i) preparing a dip-treatment composition containing said substance of interest and a branched polysaccharide and (ii) applying this dip-treatment composition to the roots of said plant.

24. The method as claimed in claim 23, characterized in that said composition was prepared a few days before application to the plant.

25. A method for planting a plant, comprising the step of planting a plant in a substrate which allows growth of the plant, characterized in that the plant roots are coated with a composition as claimed in claim 1.

26. The method as claimed in claim 24, characterized in that the coating of the roots of the plant was carried out more than 12 hours before the step of planting the plant.
